(19) United States
(12) Patent Application Publication
(10) Pub. No.: US 2014/0262415 A1
(43) Pub. Date: Sep. 18, 2014

(54) SYSTEM FOR CONTROLLING POWER IN A JUNCTION BOX

(71) Applicant: John Joseph King, Wheaton, IL (US)

(72) Inventor: John Joseph King, Wheaton, IL (US)

(21) Appl. No.: 13/835,421

(22) Filed: Mar. 15, 2013

(51) Int. Cl. H02G 3/08; H02G 1/00

(52) U.S. Cl. CPC H02G 3/08; H02G 1/00
USPC 174/59; 29/825

(57) ABSTRACT

A system for controlling power in a junction box is described. The system comprises a junction box adapter having a plurality of flanges for coupling to a junction box of an electrical network, and a plurality of connector elements; and an electrical component, which enables the control of power, inserted in the junction box adapter; wherein a plurality of connector elements of the junction box adapter are positioned to receive corresponding contact elements of the electrical component

### FIELD OF THE INVENTION

The present invention relates generally to a system for and method of controlling power in a junction.

### BACKGROUND OF THE INVENTION

Conventional switches and outlets, such as light switches, timers, outlets, motion detectors, or other devices installed in conventional junction boxes (such as an electrical junction box in a home), are often difficult and time consuming to replace. For example, it is typically necessary to turn the power to the switch on or off. In many cases (such as where fuses or circuit breakers are not labeled clearly or an individual in not confident that a particular switch or outlet is actually on a particular fuse or circuit breaker), individuals who are not certified electricians will turn off the power to the entire house. When the power to the entire house is turned off, the individual will have to reset various clocks and timers in the house, which can be time consuming. Accordingly, replacing switches and outlets is a time consuming (if performed by an individual), or expensive and inconvenient (if performed by an electrician hired to replace the switch or outlet).

### SUMMARY OF THE INVENTION

A system for controlling power in a junction box is described. The system comprises a junction box adapter having a plurality of flanges for coupling to a junction box of an electrical network, and a plurality of connector elements; and an electrical component, which enables the control of power, inserted in the junction box adapter; wherein a plurality of connector elements of the junction box adapter are positioned to receive corresponding contact elements of the electrical component.

According to an alternate embodiment, a system for controlling power in a junction box comprises a junction box adapter having a plurality of flanges for coupling to a junction box of an electrical network, and a plurality of connector elements; and an electrical component, which enables the control of power, inserted in the junction box adapter; wherein the plurality of connector elements comprises a first plurality of connector elements adapted to receive a first type of electrical component and a second plurality of connector elements adapted to receive a second type of electrical component.

A method of controlling power in a junction box is also described. The method comprises providing a junction box adapter having a plurality of connector elements adapted to receive contact elements of an electrical component which enables the control of power; receiving the electrical component in the junction box adapter; and coupling power from wires in the junction box to the electrical component by way of the junction box adapter.

### BRIEF DESCRIPTION OF THE DRAWINGS

FIG. 1 is a perspective view of an arrangement of wiring elements having a junction box adapter for a junction box adapted to receive a single electrical component;

FIG. 2 is a perspective view of an arrangement of wiring elements having a junction box adapter for a junction box adapted to receive multiple electrical components;

FIG. 3 is a plan view of the inside of the back portion of a junction box adapter;

FIG. 4 is a plan view of the outside of the back portion of a junction box adapter of FIG. 3;

FIG. 5 is a plan view of a coupling element for coupling between common nodes on the back portion of a junction box;

FIG. 6 is a plan view of the outside of the back portion of a junction box having the coupling elements of FIG. 5;

FIG. 7 is an enlarged view of an area of the back portion of a junction box showing a strain relief element;

FIG. 8 is cross sectional view of the back portion of the junction box and the strain relief element of FIG. 7;

FIG. 9 is a plan view of a connector which may be attached to the back portion of the junction box;

FIG. 10 is a cross-sectional view of the connector of FIG. 9;

FIG. 11 is a perspective view of the inside of the back portion having the connector of FIG. 9;

FIG. 12 is a perspective view of the outside of the back portion having the connector of FIG. 9;

FIG. 13 is a perspective view of the inside of the back portion having an isolation element which receives the connector of FIG. 9;

FIG. 14 is top plan view of the outside of the back portion having an isolation element which receives the connector of FIG. 9;

FIG. 15 is a cross-sectional view of the back portion of FIG. 13 taken at lines 15-15;

FIG. 16 is a plan view of a connector according to an alternate embodiment;

FIG. 17 is a perspective view of a portion of the back portion and the connector of FIG. 16 and a retaining element;

FIG. 18 is perspective view of the arrangement of FIG. 17 with connector and retaining element being assembled in the back portion;

FIG. 19 is cross-sectional view of the assembly of FIG. 18 taken at lines 19-19,

FIG. 20 is a top plan view of the arrangement of FIG. 18;

FIG. 21 is cross-sectional view of the assembly of FIG. 18 having the retaining element taken at lines 19-19;

FIG. 22 is a block diagram of a spring-loaded connector;

FIG. 23 is a top plan view of the spring-loaded connector in an isolation element associated with a back portion of a junction box adapter;

FIG. 24 is a cross-sectional view of the spring-loaded connector and an isolation element associated with a back portion of a junction box adapter having a retaining element taken at lines 24-24;

FIG. 25 is a cross-sectional view of the spring-loaded connector in a compressed state in an isolation element associated with a back portion of a junction box adapter having a retaining element;

FIG. 26 is a perspective view of a coupling element for receiving a corresponding rail of an electrical component;

FIG. 27 is a frontal view of an electrical component having rails positioned in rail guides of a junction box adapter;

FIG. 28 is a perspective view of an electrical component having moveable contact elements on the side of the electrical component;

FIG. 29 is a frontal view of the electrical component of FIG. 28 showing the rails and moveable contact elements;

FIG. 30 is a perspective view of a rail guide having a receiving a rail of a contact element;

FIG. 31 is a cross-sectional view of the rail guide of FIG. 30 taken at lines 31-31;

FIG. 32 is a cross-sectional view of the rail guide of FIG. 30 receiving a contact and a rail of an electrical component;

FIG. 33 is an expanded view of a latching arrangement in a first state;

FIG. 34 is an expanded view of a latching arrangement in a second state;

FIG. 35 is a cross-sectional view of a latching arrangement in the first state taken at lines 35-35;

FIG. 36 is a frontal view of an electrical component having electrical contacts positioned on a side of the electrical component to make electrical connections to corresponding contacts of another electrical component;

FIG. 37 is a side view of the electrical component of FIG. 36;

FIG. 38 is a side view of another electrical component having the corresponding electrical contacts for receiving the electrical contacts of the electrical component of FIG. 36;

FIG. 39 is a block diagram of an electrical component enabling wireless communication; and

FIG. 40 is a flow chart showing a method of implementing a junction box adapter in a junction box.

### DETAILED DESCRIPTION OF THE DRAWINGS

The various embodiments allow an individual to easily replace an electrical component (such as a light switch, a light timer, a motion detector, an ambient light detector, an electrical outlet or other electrical control device, for example) in a junction box. The various embodiments enable an individual (who is not a trained electrician) change the electrical component without turning the power (provided to the junction box having the electronic control device) off. A junction box adapter positioned within the junction box is coupled to the wires provided to junction box, and the junction box adapter receives an electrical component having contacts which make a contact with appropriate contact elements (such as contact portions of connector elements) of the junction box adapter. The connectors of the junction box adapter are preferably recessed or otherwise not exposed when an electrical component is not within the junction box adapter, making it safe for an individual to replace the electronic control box without turning off the power to the junction box. The junction box adapter preferably has terminals for receiving predetermined voltages (e.g. power, ground and earth ground), and corresponding receiving contacts (e.g. of connectors in a certain area) for receiving corresponding contacts of the electrical component, to enable the junction box to be a universal adapter. That is, the junction box adapter enables a conventional junction box to receive any electrical component and having the correct wires of a junction box connected at the appropriate terminals of the junction box adapters so that the electrical component performs a desired function, as will be described in detail below. The electrical component can preferably be changed without the user of tools.

Turning first to FIG. 1, a perspective view shows an arrangement of wiring elements having a junction box adapter for a single electrical component. A junction box adapter 102 is adapted to be positioned in a junction box 103 and receive an electrical component 104. The junction box adapter 102 is a rectangular structure comprising a top portion 106 having a window 108. A bottom portion 110 has a recess 112. A pair of side portions is coupled to the top and bottom portions. In particular, a first side portion 114 comprises crossbar elements 116 and 118, creating widows 120, 124 and 126. A second side portion opposite the first side portion similarly comprises crossbar elements 128 and 130, creating windows 132, 134 and 136. While the crossbar elements generally improve the strength of the junction box adapter, they can also function as guide rails for receiving corresponding rails of an electrical component inserted into the junction box, as will be described in more detail below. While two crossbar elements are shown on opposite sides, it should be understood that greater or fewer crossbar elements could be used. As will also be described in more detail below, the crossbar elements could include contact elements to provide an electrical connection to a connector on the electrical component.

A back portion 138 is positioned between the first and second side portions, and according to various embodiments, comprises through holes 140 for receiving connector elements. As will be described in more detail in reference to FIG. 3, the holes can be selectively placed for receiving corresponding contact elements of different electrical components. A front portion 141 has a plurality of elements for coupling the junction box adapter to a junction box and for receiving the electrical component 104 and optionally a cover plate. In particular, flanges 142 and 144 have through holes, which may be threaded, positioned to align with corresponding flanges having threaded holes for receiving a screw to secure the junction box adapter to a junction box. While the flanges 142 and 144 are shown in a particular position, the flanges could be located in any position to align with treaded holes of a junction box which are normally used to secure a conventional switch or outlet to the junction box. The number and location of the flanges 142 and 144 are shown by way of example, and any number of flanges could be positioned at any necessary locations to secure the junction box adapter to the junction box. The front portion 141 also includes receiving latching elements for receiving corresponding latching elements of the electrical component 104. Latch elements 146 enable the electrical component to be removably attached to the junction box adapter 102, as will be described in more detail below. Further, threaded portion 148 can receive screws for attaching a cover to the junction box adapter.

The electrical component 104 comprises an actuator element 150, shown here as a switch element of a light switch. While a light switch is shown by way of example, it should be understood that the junction box adapter 102 is adapted to receive any kind of electrical component, such as a dimmer light switch, a light timer, a motion sensor light switch, a two-prong electrical outlet, a three prong electrical outlet, for example, or any other electrical control device for controlling a light or other appliance. A will be described in more detail below, a dummy electrical component adapter may be implemented to fill a portion of a junction box adapter which is not being used (e.g. in a double junction box having a working electrical component in one side of the box). The electrical component 104 comprises alignment members shown here as two alignment members 152 and 154 (per side) which are positioned to align with and lie within a recess of corresponding crossbar elements of the junction box adapter 102. A latching element 158 is positioned on the electrical component 104 to align with the latching element 146.

The junction box adapter 102 is designed to fit into a conventional junction box 103. The junction box 103 comprises a top portion 162, a bottom portion 164, side portions 166 and 168, a front portion 169, and a rear portion between the side portions. Each of side portions of the junction box comprises punch outs 177. Flanges 170 and 172 each have a threaded hole for receiving a screw for securing a junction box adapter 102. As is well known, when the punch outs 177 are removed, conduits 178 having electrical wires 180 may be used with the junction box, where ends 180 of the wires extend into the box. While flanges are shown on a front portion of the junction box, some junction boxes may include a threaded portion on the front portion itself rather than a flange. The flanges 142 and 144 of the junction box adapter may be positioned to align with the threaded holes on the flanges 170 and 172. Alternatively, some junction boxes may not have a front portion, but rather only include female, threaded receptacles on the sides of the junction box, flush with the front end of the sides of the junction box. The flanges 142 and 144 of the junction box adapter would be aligned with the female, threaded receptacles on the sides of the junction box. According to an embodiment, the flanges 142 and 144 could extend all the way across the top or bottom of the box, and not have holes in particular locations to enable a user to drill a hole at the appropriate location for a given junction box.

A cover plate 184 may be provided to cover the junction box adapter 103 for aesthetic purposes. Accordingly, a recess 186 will allow access to the electronic component 104, which screw holes 188 enable securing the cover plate 184 to the junction box adapter. A recess adapter 190 may also be used, for structural purposes to provide additional support for the junction box adapter. The recess adapter 190 comprises a plurality of sides 193, 194, 196 and 198 forming a frame having a recess 199. The recess adapter 190 provides support for the junction box adapter by filling in a gap between the bottom of the junction box adapter and the bottom of the junction box, reducing strain on the flanges of the junction box adapter and the junction box and the screw securing the flanges. That is, the recess adapter 190 has a height h₅ which is equal to the distance from the bottom of the junction box to the bottom of the junction box adapter when the junction box adapter is installed in the junction box and the flanges are aligned. The recess 199 enables any wires to pass through the bottom of the junction box adapter and through the junction box itself. The junction box adapter may be made of a non-conductive material, such as a plastic material.

The dimensions of the junction box adapter 102 are selected to securely attached to the junction box, while providing as much room at possible to receive an electrical component 104. The junction box 103 as shown has a width w₁, a height h₁, and a depth d₁. Depending upon the type of junction box, the dimensions of the opening of the front of the junction box are generally less than width w₁ and height h₁. The dimensions of the junction box adapter have a width w₂, a height h₂, and a depth d₂, which are less that the dimensions width w₁, a height h₁, and a depth d₁. The width w₁ is preferably just less than the width of the opening of the front portion 141. The depth d₂ is less than d1, to allow enough room for contact elements and wires connected to the contact elements to fit into the box. According to one embodiment, the side portions of the junction box adapter extend as shown by the dashed lines 149 to ensure that any connector elements inserted in the back portion 108 of the box could not make contact with the junction box. The height h₂ of the junction box 102 is selected so that the top and the bottom of the junction box fit between the flanges 170 and 172, and the flanges 142 and 144 align with the flanges 170 and 172, respectively.

The junction box adapter could be formed using any type of molding process, such as injection molding for example. While the junction adapter box is preferably a single piece, the junction box adapter could be assembled from a plurality of pieces. Although various windows are shown, the windows are generally provided to reduce the material requirements of the junction box adapter and therefore reduce the cost. However, the windows could be smaller to provide greater structural integrity to the junction adapter box, or be eliminated if there is no need to route any wires from the box or connectors associated with an electrical component. Alternatively, windows could be created by portions of the junction box adapter which are removed as desired based upon the locations of wires which may need to pass through the junction box adapter. However, wires are generally routed outside the box, and only connected to connector elements on the box, and particularly behind the box as will be described in more detail below.

Turning now to FIG. 2, a perspective view shows an arrangement of wiring elements having a junction box adapter for multiple electrical components. A junction box adapter 202 is adapted to be positioned in a junction box and receive two electrical components 104. The junction box adapter 202 is a rectangular structure comprising a top portion 204 having a window 206. A bottom portion 208 has a recess 210. A pair of side portions is coupled to the top and bottom portions. In particular, a first side portion 202 comprises crossbar elements 216 and 216, creating widows 218, 220 and 222. A second side portion similarly comprises crossbar elements 224 and 226, creating windows 228, 230 and 232. Guide rails 234 and 236, which would include recesses on both sides of the guide rails for receiving corresponding rails associated with two electrical components, are provided between a front portion divider 238 of a front portion 239 and a back portion 240.

The back portion 240 is positioned between the first and second side portions, and according to various embodiments, comprises through holes 140 for receive a connector. The holes in the back portion 240 are implemented as shown in FIGS. 3 and 4, but with first set of holes as shown in FIG. 3 for a first electrical component on one side of the front portion divider 238 and a second set of holes as shown in FIG. 3 for a second electrical component on the other side of the front portion divider 238. Latch elements 246 and threaded portions 248 are also provided. The front portion 239 has a plurality of elements coupling the junction box adapter to attach the junction box adapter to a junction box, and for receiving the electrical component 104 and optionally a cover plate. In particular, flanges 250-256 have through holes, which may be threaded, positioned to align with corresponding flanges having threaded holes for receiving a screw to secure the junction box adapter to a junction box. While the flanges 250-256 are shown in a particular position, the flanges could be located in any position to align with treaded holes of a junction box which is normally used to secure a conventional switch or outlet to the junction box.

The junction box adapter 202 is designed to fit into a conventional junction box 260. The junction box 260 comprises a top portion 262, a bottom portion 264, side portions 266 and 268, a front portion 269, and a rear portion 270. Each of sides of the junction box comprises punch outs 177. Flanges 272-278 each have a threaded hole for receiving a screw for securing a conventional switch or outlet. As is well known, when the punch outs 177 are removed, conduits 178 having electrical wires 180 may be used with the junction box. A recess adapter 280 may also be used, for structural purposes to provide additional support for the junction box adapter. The recess adapter 280 comprises a plurality of sides 282-288 and a divider portion 290 forming a frame having recesses 292 and 294. The recess adapter 280 provides support for the junction box adapter by filling in a gap between the bottom of the junction box adapter and the bottom of the junction box, reducing strain on the flanges of the junction box adapter and the junction box and the screw securing the flanges. A cover plate 296 may be provided to cover the junction box adapter 202 for aesthetic purposes. Accordingly, recesses 298 will allow access to electronic components 104, which screw holes 299 enable securing the cover plate 296 to the junction box adapter 202.

The dimensions of the junction box adapter 202 are also selected to be securely attached to the junction box. The junction box 103 as shown has a width w₃, a height h₃, and a depth d₃. Depending upon the type of junction box, the dimensions of the opening of the front of the junction box are generally less than width w₃, a height h₃, and a depth d₃. The dimensions of the junction box adapter have a width w₄, a height h₄, and a depth d₄, which are less that the dimensions width w₃, a height h₃, and a depth d₃.

Turning now to FIG. 3, a plan view shows the inside portion of the back of a junction box adapter. The junction box adapter is configured to receive electrical components 104 having common locations of terminals based upon the type of device. For example, one portion 302 of the back portion of the junction box adapter could have connector elements associated with a first type of electrical component, while another portion 304 could have connector elements associated with a second type of electrical component. In particular, recesses 306, 308 and 310 adapted to receive connector elements for mating with corresponding contact elements of a first type of electrical component. Similarly, recesses 312, 314, and 316 could be positioned to receive contact elements of a second type of electrical component for mating with corresponding contact elements of electrical components. It should be apparent from the orientation of the recesses associated with the particular portions 302 and 304 that a given electrical component can only be inserted in one orientation. Although a particular orientation of recesses associated with two types of electrical components is shown by way of example, it should be understood that more than 3 contact elements could be provided for a given electrical component, the connector elements associated with a given electrical component could be distributed across the entire back of the junction box adapter, and more than two types of electrical components could be accommodated.

By way of example, a first type of electrical component could be an electrical outlet, while a second type of electrical component could be light switch. The locations of the contact elements for the electrical components are placed based upon the location of connector elements of the junction box adapter, where different types of electrical components have different arrangements of contact elements to prevent a user from inadvertently inserting the wrong type of electrical component in a junction box. For example, the locations of contacts on an electrical outlet would be different than the location of contact elements on a switch. The locations of contact elements for a given type of device could be different. For example, electrical outlet could be adapted to receive either two-prong plugs or three-prong plugs (having both a ground contact and a neutral contract in addition to a power contact). Because it would be dangerous to install an electrical outlet adapted to receive 3 prongs when the junction box adapter is only wired to receive an electrical output adapted to receive a plug having two prongs. That is, because the neutral contact provides a chassis ground for the case of the appliance which is plugged in, if the neutral contact of the plug on the appliance is not connected to a neutral contact on junction box adapter (where the neutral contact is coupled to a neutral node of the electrical network), a hazardous situation could exist where a user of the appliance could receive an electrical shock. According to one embodiment, a non-conductive element could be included in a recess for receiving a corresponding contact element on the electrical component to prevent a three-prong outlet from being inserted into a junction box adapter only wired to receive to a two-prong outlet. That is, the non-conductive element of a junction box adapter only wired with for a two prong electrical outlet would interfere with a three prong electrical outlet if it is inserted into the junction box adapter. Further, other electrical components such as a light switch could have different numbers of contact elements. While a conventional light switch could have two contacts, another light switch could be a multi-function switch, and therefore could provide fan controls in addition to controlling the light, for example. Accordingly, each unique electrical component has a predetermined configuration of contracts, where the electrical component can only be inserted into the junction box adapter and make electrical connections to corresponding contact elements of connectors of the junction box adapter when the connectors are provided in the correct locations. Alternatively, connectors could be provided in all of the recesses of the junction box adapter. That is, while a kit could be provided to a user with connector elements separate from the junction box adapter to enable a user to insert the connector elements in desired locations based upon known uses (i.e. known electrical components), the junction box adapted could come with electrical connectors positioned in each location of the various available locations as shown in FIG. 3 for example.

Turning now to FIG. 4, a plan view shows the outside of the back portion of a junction box adapter of FIG. 3. In particular, strain relief elements, including horizontal stain relief elements 402 and vertical strain relief elements 404 are provided to reduce the stain on the connection point for wires attached to connectors inserted in the recesses, as will be described in more detail in reference to FIGS. 7 and 8. The back portion of the junction box adapter could also be labeled to make it easier to correctly connect the wires in the junction box to connector elements in the recesses of the junction box adapter. For example, labels for the connector elements would be printed on the back of the junction box adapter as shown, and the junction box of a new house could be completely wired, allowing a home owner to install switches and outlets a later time, for example when wall colors have been decided.

Turning now to FIG. 5, a plan view shows a coupling element for coupling between common nodes on the back portion of a junction box. In particular, the coupling element 502 comprises a conductive element 504 coupled between a first connector 506 having an attachment portion 508 and a second connector 510 having an attachment portion 512. The attachment portions 508 and 512 may be a crimped portion or a soldered connector, for example. As shown in FIG. 6, the outside portion of the back portion of a junction box for receiving two electrical components includes the coupling elements of FIG. 5. As shown in FIG. 6, the coupling element 502 is inserted in a conductor guide 602. The conductor guide 602 is similar to the stain relief 402, except that it could be longer and may have smaller dimensions such that, when the coupling element 502 is inserted in the conductor guide 602, it will remain in place so that it is easier to secure the connector elements to a contact element, as will be described in more detail below. As is apparent from FIG. 6, the power and ground contacts for the two portions of the back of the junction box are coupled together. According to an alternate embodiment, all of the recesses associated with a common node (e.g. ground) could be placed in the same vertical location such that a “ground bus” could be implemented. That is, a single coupling element 502 could extend horizontally along the back portion of the junction box to enable coupling to any ground contacts which are inserted in recesses of the back portion. Accordingly, the coupling elements 502 will reduce the wiring requirements inside the box by providing a better arrangement of wires on the junction box adapter, and the use of connectors in the recesses of the junction box adapter will eliminate the requirement for twist type connectors for attaching two or more wires. Not only will there be fewer wires in the junction box, but the connection will be more secure, and therefore reduce the chance of inadvertent shorting which may lead to a hazardous condition.

Turning now to FIG. 7, an enlarged view shows an area of the back portion of a junction box having a strain relief element. As shown in FIG. 7, a nut 702 coupled to a connector 703 in a recess of the back portion secures an appropriate wire 704 of the wiring system at a stripped end 706 of the wire. The wire is retained in the strain relief 402, where an end 708 of the wire extends out of the strain relief. The strain relief element 402 is preferably located a distance d₇ from the nut 702 to prevent strain on the wire. As shown in the cross-sectional view of FIG. 8, the strain relief comprises two opposite facing elements comprising a first strain relief element 802 having a post 804 and a flange 806 and a second strain relief element 808 comprising a post 810 and a flange 812. The first and second strain relief elements 802 and 808 are arranged to enable the wire 704 to be pushed through the flanges 806 and 812, but retained within the strain relief. That is, the width w₅ between the flanges is generally greater than the diameter of the wire 704, which is less than the width w6 between the posts 804 and 810. The post have a certain flexibility which enables the wire 704, having a conductive core 814 and insulator coating 816, to be pushed through and retained by the strain relief. Although the width w₆ between the posts would leave some separation having a width w₇ on either side of the wire 704, the width w₆ could be chose so that the wire 704 fits snuggly in the strain relief, further decreasing the chances that the wire 704 could become detached from the connector 703 due to movement of the junction box adapter.

Turning now to FIGS. 9-12, various views show a connector which is attached to the back portion of the junction box. As shown in the plan view of FIG. 9, a connector element 902 comprises oppositely threaded portions 904 and 906 on either side of an unthreaded portion 908, where the threaded portion 904 is a contact portion which is adapted to receive nut 910 and the threaded portion 906 is adapted to receive the nut 912. As can be seen in the cross-sectional view of FIG. 10 taken at lines 10-10, a contact receptacle portion 1002 of the threaded portion 904 has a series of beveled edges which guide a contact into the contact receptacle portion 1002. In particular, a beveled outer ring, shown by a top edge 1004 and a bottom edge 1006 of the contact receptacle portion. The beveled outer ring leads to a conical portion, shown by a top edge 1008 and a bottom edge 1010. The contact receptacle portion 1002 has a depth d₈ which is selected to properly receive a corresponding contact of an electrical component. A slot 1012 enables securing a nut 910 to the threaded portion 904 as shown FIG. 11. The nut 912 can be used to secure the connector element 902 to the back portion 108 as shown in FIG. 12. Because the nut 910 is tightened all the way to the unthreaded portion 908, the nut 910 can be tightened to securely attach the connector element 902 to the back portion 108 after nut 918 is tightened. The nuts 910 and 912 can be self-locking nuts, or lock washers could be used to ensure that the connector element 902 remains securely attached to the back portion 108.

According to a further improvement in FIG. 13, the back portion 108 could have an isolation element which receives the connector of FIG. 9. The isolation element 1302 comprises a first side element 1304 and a second side element 1306 on either ends of a front portion 1308. The front portion 1308 comprises an opening 1310 which is adapted to receive a contact element of an electrical component. As shown in FIG. 13, the width w₁₂ can be approximately equal to the width w₁₁ so that the opening substantially aligns with the contact receptacle portion of the threaded portion 904. Alternatively, the opening 1310 can be smaller than the contact receptacle portion so that the end of the threaded portion 904 will abut the inside wall of the front portion 1308. By including an isolation element, connector elements coupled to the “live” electrical wiring would not be exposed when an electrical component is not positioned in the junction box adapter. Such an arrangement would make it safer for a user to change an outlet, switch, or other electrical component without turning of the power to the junction box. A cross-sectional view the back portion of FIG. 13 taken at lines 15-15 is shown in FIG. 15. The distances d₉ and d₁₀ are selected so that the connector is securely attached to the back portion 108, while allowing enough room to securely attach wires to portion 908.

Turning now to FIG. 16, a plan view shows a connector according to an alternate embodiment. In particular, a connector 1602 having a head 1604 and a threaded portion 1606 separated by an unthreaded portion 1608. The unthreaded portion 1608 has a distance d₁₁ to prevent stripping of the threads when the connector is placed in the back portion 108. As will be described in more detail below, the head 1604 has a contact portion 1612 to which an electrical connection can be made to a contact of an electrical component 104. The head has a depth d₁₂, which may be selected to fit into a recessed portion of an isolation element. As shown in the embodiment of FIG. 17, the connector 1602 of FIG. 16 can be placed within a recess of an isolation element. That is, the connector 1602 can be placed in an elongated hole 1702 at an upper portion 1703 and moved to a lower portion 1704, where it is retained by a retaining element 1705. The elongated hole 1702 has a width w₁₃ which is just slightly larger than the width of the threaded portion 1606 to enable the connector element 1602 to be inserted into the elongated hole 1702 without damaging the threaded portion 1606, while minimizing the movement of the connector 1602. The retaining element 1705 comprises a head portion 1706 extending from a top 1708 to a bottom 1710. The head portion 1706 is coupled by a shaft portion 1712 to retaining element 1714. The shaft portion has a width w₁₄, while retaining element has a width w₁₅ at its widest point.

The retaining element 1705 may be made of a flexible material to enable the retaining element to be inserted into the elongated hole 1702 and retained in the elongated hole unless the retaining element 1714 is physically manipulated so that the retaining element is removed. For example, the retaining element 1705 could be made of a flexible rubber material. After the threaded portion 1606 of the connector 1602 is inserted through the elongated hole 1702 at the top portion 1703 so that the head 1604 abuts the back portion 108, the connector 1602 can then be moved downward so that the head 1604 is positioned in the isolation element 1716. The retaining element 1705 is then placed above the retaining element, as shown in the perspective view of FIG. 18. As can be seen, an aperture 1718 is provided to enable an electrical connection to the connector 1602.

As shown in FIG. 19, the head 1604 of the connector can be positioned in the isolation element 1716 so that it will not turn when a screw on the threaded portion 1606 is turned. That is, head 1604 could be a 6-sided head, wherein two opposite sides of the head abut and are flush with corresponding inner sidewall regions of the isolation element 1716 for receiving the head as shown, preventing the head from turning when a nut is attached. A nut 1902 can be used to secure the connector to the back wall. Accordingly, d₁₂ of the head is slightly smaller than d₁₃ of the isolation element 1716. Further, the width between two opposite sides of the head is slightly less than the width w₁₂. While the retaining element 1705, as shown in FIG. 20, would also function to secure the connector to the back wall by trapping the connector 1602 in the isolation element 1716, the nut 1902 will further aid in securing the connector 1602 to the back portion. A second nut 1904 could be used to secure an electrical wire, such as an electrical wire in the junction box, to the connector 1602. The cross-sectional view of the connector 1602 and retaining element 1705 within the back portion 108 of FIG. 21 further shows how the connector 1602 is secured within the isolation element 1716. As should be apparent from FIG. 21, the connector 1602 is only exposed within the recess 1906 of the isolation element, and is therefore would not be exposed when an electrical component 104 is not located in the junction box adapter. Accordingly, the arrangement of connector elements with isolation elements enables a user to safely insert and remove electrical components 104 while power is applied to connectors.

Turning now to the embodiment of FIGS. 22-25, a spring-loaded connector may be implemented. The embodiment of FIGS. 22-25 is similar to the embodiment of FIGS. 16-21 except that a spring is provided within the isolation element to enable the connector element to move within the back portion of the wall. A spring loaded connector element will help ensure that there is a good electrical contact between an electrical contact of an electrical component 104 and a contact portion of a connector element coupled to the back portion 108. While electrical contacts of the electrical component 104 could be spring loaded, the electrical contacts of the electrical component 104 could be fixed, while the connector elements coupled to the back portion 108 could be spring loaded as shown in FIGS. 22-25. More particularly, a connector element 2200 of FIG. 22 has a head 2202 and an unthreaded portion 2204 coupled between the head 2202 and a threaded portion 2206. A spring 2208 can fit over the threaded portion 2206 and unthreaded portion 2204, and abut the head 2202, as shown in the top plan view of FIG. 23. The distance d₁₃ is generally greater than the distance d₁₁ to prevent the stripping of the threaded portion when the connector element 2200 is moved. As can be seen in FIG. 23, the head 2202 of the connector element 2200 abuts an isolation element 2302. As shown in the cross-sectional view of FIG. 24, an aperture 2403 enables a contact of an electrical component 104 to make an electrical connection with the head 2202, which comprise a contact portion of the connector element 2200. A wire 2404 is also shown in FIG. 24.

As shown in the embodiment of FIG. 25, the connector element 2202 is advanced by a distance d₁₅, creating a recess 2402 with the isolation element and creating a corresponding gap 2504 between the back portion 108 and the nut 1902. When an electrical component 104 is inserted into the junction box adapter 102, a contact 2506 of electrical component makes electrical contact with the head 2202, causing the contact 2200 to move as shown in FIG. 25. The spring 2208 will not only ensure that the contact 2506 contacts the head 2202, but that a good electrical connection is formed.

Turning now to FIG. 26, a perspective view shows a coupling element, implemented here as a rail guide for receiving a corresponding alignment member, shown here as a corresponding rail, of an electrical component. The guide rail 2602 comprises a u-shaped retaining element 2604 having a recess 2606. As shown in the frontal view of FIG. 27, the rails 152 and 154 fit into corresponding guide rails 2602. Rails 2702 and 2704 on the other side of the electrical component 104 are also positioned within corresponding guide rails 2602.

According to an alternate embodiment of FIGS. 28-32, electrical contacts for the electrical component 104 can be placed on the side of the electrical component, where modified guide rails are used to receive both the contacts for the electrical component 104 and the rails 152 and 154. The contacts 2802 and 2804 could be spring loaded contacts which move into and out of the side of the electrical component 104, or bend with respect to the side of the electrical component 104. As shown in the embodiment of FIG. 29, the contacts 2802, 2804, 2902 and 2904 are fully extending. Accordingly, a user would depress (or bend) the contacts (so that they would align with the rails 152 and 154) prior to inserting the electrical component 104 into the rail guides of the junction box adapter. The contacts would remain in that state until the electrical component 104 is fully inserted into the junction box adapter, at which point the contacts would revert to their normal extended state to make electrical connections with contacts on the rails.

An example of a modified rail 3000 is shown in FIG. 30, where the u-shaped rail also has a recess 3006 and a contact portion 3008. As can be seen in the cross-sectional view of the taken at lines 31-31, the contact portion 3008 is recessed and is a portion of a contact 3100 which is electrically coupled to a connector attached to the back portion 108. As can be seen in the embodiment of FIG. 32, a rail 152 and a contact portion 3008 of an electrical component 104 can be inserted within the rail guide. As is apparent from the embodiment of FIGS. 28-32, the electrical connectors of the junction box adapter are also not exposed on the inside of the junction box adapter.

Turning now to FIGS. 33-35, a latching arrangement for securing the electrical component to the junction box adapter is shown. In particular, an expanded view shows a latching arrangement in a first state. As shown in FIG. 33, a latch 3301 of the electrical component 104 comprises a shoulder portion 3302 which is moveable (by a flange 3304) between a locking position, as shown in the cross sectional view of FIG. 33 for example, or the releasing position as shown in the cross-sectional view of FIG. 34. A user who desires to remove the electrical component 3104 moves the flange 3304 (such as with a finger or a flat-head screw driver) as shown by the arrow to release the shoulder from the latch element 146, shown here as a flange of the front portion of the junction box adapter. The shoulder 3302 could be movable between the locking position and the releasing position by a flexible portion 3502 shown in FIG. 35.

By making it both easy and safe to remove an electrical component, it may be possible for a supplier of electrical components to provide customization of the components. While electrical components (and corresponding face plates) typically come in a limited number of colors (e.g. white and beige), a supplier of electrical components could provide a greater number of colors, allowing a user to change the appearance of their electrical components to match room décor, for example. While the latch 3301 and the latch element 146 combine to secure the electrical component 104 to the junction box adapter 102, where the electrical component can easily be removed, it should be understood that other latching elements could be implemented.

Turning now to FIG. 36, a frontal view of an electrical component having electrical contacts positioned on a side of the electrical component to make electrical connections to corresponding contacts of another electrical component is shown. A side view of the electrical component of FIG. 36 is shown FIG. 37. A side view of another electrical component having the corresponding electrical contacts for receiving the electrical contacts of the electrical component of FIG. 36 is shown in FIG. 38. That is, contact elements 3608-3614 will mate with corresponding contact elements 3804-3810 when the two electrical components are placed in the junction box adapter. Accordingly, electrical components could communicate, improving the functionality of the electrical components. For example, a wireless adapter could be implemented in a junction box with a timer to enable timing data. That is, timing characterization data associated with the timer could be downloaded to a timer in one side of a junction box adapter from a wireless adapter on the other side of the junction box adapter.

Turning now to FIG. 39, a block diagram of electrical component enabling wireless communication is shown. In particular, the antenna 3904 receives data by way of wireless communication signals according to a predetermined wireless communication protocol. The data may be sent to the data transceiver 3902 by way of a computer, such a computer 130, having or in communication with a corresponding data transceiver. The received data is coupled to a combined mixer/voltage controlled oscillator 3906, the output of which is coupled to an intermediate frequency (IF) circuit 3908. Based upon outputs of the IF circuit and a phase locked loop (PLL) 3910, a mixer 3912 generates the received data. An analog-to-digital converter (ADC) 3914 then generates digital data representing the timing characterization data.

The data transceiver 3902 may also provide data to the data transceiver for transmission to a computer. Data to be transmitted from the data transceiver 3902 is coupled to a digital-to-analog converter (DAC) 3916, the output of which is coupled to a modulator 3918 which is also coupled to a PLL 3920. A power amplifier receives the output of the modulator to drive the antenna 3904 and transmit the data. According to one embodiment, the data transceiver could implement the IEEE Specification 802.11 wireless communication standard. While the circuit of FIG. 39 is provided by way of example, other wireless data transceivers could be employed according to the present invention.

Turning now to FIG. 40 is a flow chart shows a method of implementing a junction box adapter in a junction box. In particular, a junction box adapter having coupling elements for receiving alignment members of an electrical component is provided at a step 4002. Connectors at predetermined locations on the junction box adapter are implemented at a step 4004. Wires of a junction box to appropriate connector elements of the junction box adapter are connected at a step 4006. The junction box adapter to the junction box is coupled at a step 4008. An electrical component into the junction box adapter is inserted at a step 4010. The various elements of the method of FIG. 40 may be implemented according to the disclosure of FIGS. 1-39 as described, or using some other suitable elements. While specific elements of the method are described, it should be understood that additional elements of the method, or additional details related to the elements 4002-4010, could be implemented according to the disclosure of FIGS. 1-39.

It can therefore be appreciated that the new and novel timer and method of implementing a timer has been described. It will be appreciated by those skilled in the art that numerous alternatives and equivalents will be seen to exist which incorporate the disclosed invention. As a result, the invention is not to be limited by the foregoing embodiments, but only by the following claims.

I claim:

1. A system for controlling power in a junction box, the system comprising:
a junction box adapter having a plurality of flanges for coupling to a junction box of an electrical network, and a plurality of connector elements; and
an electrical component, which enables the control of power, inserted in the junction box adapter;
wherein a plurality of connector elements of the junction box adapter are positioned to receive corresponding contact elements of the electrical component.

2. The system of claim 1 wherein the junction box adapter further comprising a coupling element to receive an alignment member of the electrical component.

3. The system of claim 2 wherein the coupling element comprises a guide rail, and the alignment member comprises a flange.

4. The system of claim 3 wherein the guide rail is adapted to receive an alignment member of the electrical comprising a corresponding rail.

5. The system of claim 1 wherein the plurality of connector elements are provided on a back portion of the junction box adapter.

6. The system of claim 1 wherein the plurality of connector elements are removably coupled to the junction box adapter.

7. The system of claim 1 wherein the plurality of connector elements comprises a first plurality of connector elements adapted to receive a first type of electrical component and a second plurality of connector elements adapted to receive a second type of electrical component.

8. A system for controlling power in a junction box, the system comprising:
a junction box adapter having a plurality of flanges for coupling to a junction box of an electrical network, and a plurality of connector elements; and
an electrical component, which enables the control of power, inserted in the junction box adapter;
wherein the plurality of connector elements comprises a first plurality of connector elements adapted to receive a first type of electrical component and a second plurality of connector elements adapted to receive a second type of electrical component.

9. The system of claim 8 wherein the junction box adapter further comprising a coupling element to receive an alignment member of the electrical component.

10. The system of claim 9 wherein the coupling element comprises a guide rail, and the alignment member comprises a flange.

11. The system of claim 10 wherein the guide rail is adapted to receive an alignment member of the electrical comprising a corresponding rail.

12. The system of claim 8 wherein the plurality of connector elements are provided on a back portion of the junction box adapter.

13. The system of claim 8 wherein the plurality of connector elements are removably coupled to the junction box adapter.

14. The system of claim 8 further comprising a recess adapter positioned between the junction box adapter and the bottom of the junction box.

15. A method of controlling power in a junction box, the method comprising:
providing a junction box adapter having a plurality of connector elements adapted to receive contact elements of an electrical component which enables the control of power;
receiving the electrical component in the junction box adapter; and
coupling power from wires in the junction box to the electrical component by way of the junction box adapter.

16. The method of claim 15 wherein receiving the electrical component in the junction box adapter comprises implementing a coupling element in the junction box adapter which is coupled to an alignment member of the electrical component.

17. The method of claim 15 further comprising detachably coupling the plurality of connector elements on a back portion of the junction box adapter.

18. The method of claim 15 wherein detachably coupling the plurality of connector elements on a back portion of the junction box adapter comprises coupling a first plurality of connector elements to receive a first type of electrical component and coupling a second plurality of connector elements to receive a second type of electrical component.

19. The method of claim 15 further comprising receiving a recess adapter in the bottom of the junction box.

20. The method of claim 15 wherein receiving the electrical component in the junction box adapter comprises detachably receiving.
